(19) United States
(12) Patent Application Publication
(10) Pub. No.: US 2016/0062601 A1
(43) Pub. Date: Mar. 3, 2016

(54) ELECTRONIC DEVICE WITH TOUCH SCREEN AND METHOD FOR MOVING APPLICATION FUNCTIONAL INTERFACE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHUANG HU, Shenzhen (CN); CHIH-SAN CHIANG, New Taipei (TW); LING-JUAN JIANG, Shenzhen (CN); HUA-DONG CHENG, Shenzhen (CN)

(21) Appl. No.: 14/843,063

(22) Filed: Sep. 2, 2015

(30) Foreign Application Priority Data
Sep. 3, 2014 (CN) 201410444510.8
Aug. 18, 2015 (CN) 201510506671.X

(51) Int. Cl. G06F 3/0481; G06F 3/0488; G06F 3/0482

(52) U.S. Cl. CPC G06F 3/04817; G06F 3/0482; G06F 3/0488

(57) ABSTRACT

In method for moving an application functional interface, an intermediate interface of the main desktop interface is generated and displayed. The intermediate interface includes icons, and each icon associates with an application functional interface of the main desktop interface. One of the icons is selected from the intermediate interface. An application functional interface associated with the selected icon is determined. A move operation applied on the selected icon is obtaining for moving the selected icon from a current place to a first place on the intermediate interface. A destination position of the application functional interface associated with the selected icon is determined when the operation applied on the selected icon is released in the first place. The application functional interface associated with the selected icon is updated to the destination position. The updated main desktop interface is displayed.

### CROSS-REFERENCE TO RELATED APPLICATIONS

This application claims priority to Chinese Patent Application No. 201410444510.8 filed on Sep. 3, 2014, and Chinese Patent Application No. 201510506671.X filed on Aug. 18, 2015, the contents of which are incorporated by reference herein.

### FIELD

The subject matter herein generally relates to electronic devices, and more specifically relates to, an electronic device with touch screen and a method for moving application functional interface.

### BACKGROUND

Generally, each of electronic devices displays a graphic user interface (GUI). The GUI includes a lot of icons representing application programs installed on the electronic device. An application functional interface is displayed when a user operates or touches the icon.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing an application functional interface moving system.

FIG. 2 is a block diagram of one embodiment of function modules of the application functional interface moving system in FIG. 1.

FIG. 3 is a diagrammatic view of one embodiment of a main desktop interface.

FIG. 4 is a flowchart of one embodiment of an application functional interface moving method.

FIG. 5 is a diagrammatic view of one embodiment of an intermediate interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

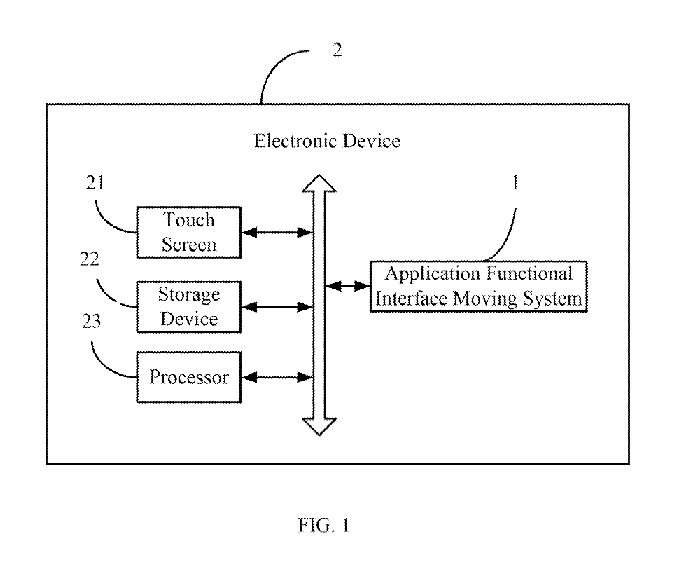

FIG. 1 is a block diagram of one embodiment of a hardware environment for executing an application functional interface moving system. The application functional interface moving system 1 is installed and run in an apparatus, for example an electronic device 2. In at least one embodiment as shown in FIG. 1, the electronic device 2 includes, but is not limited to, a touch screen 21, a storage device 22, and at least one processor 23. The electronic device 2 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

The electronic device 2 displays a main desktop interface. The main desktop interface has a plurality of application functional interfaces. The application functional interface moving system 1 can generate an intermediate interface of the main desktop interface and displays the intermediate interface. The intermediate interface is a thumbnail interface of the main desktop interface and includes a plurality of icons. Each of the icons associates with an application functional interface of the main desktop interface. A user can select one of the icons from the intermediate interface; the application functional interface moving system 1 can determine an application functional interface associated with the selected icon. The determined application functional interface needs to be moved. The application functional interface moving system 1 obtains a move operation applied on the selected icon for moving the selected icon from a current place to a first place on the intermediate interface, and determines a destination position of the application functional interface associated with the selected icon when the move operation applied on the selected icon is released in the first place. The application functional interface moving system 1 further updates the application functional interface associated with the selected icon to the destination position, and displays the updated main desktop interface.

In at least one embodiment, the storage device 22 can include various types of non-transitory computer-readable storage mediums. For example, the storage device 22 can be an internal storage system, such as a flash memory, a random access memory (RAM) for temporary storage of information, and/or a read-only memory (ROM) for permanent storage of information. The storage device 22 can also be an external storage system, such as a hard disk, a storage card, or a data storage medium. The at least one processor 23 can be a central processing unit (CPU), a microprocessor, or other data processor chip that performs functions of the application functional interface moving system 1 in the electronic device 2.

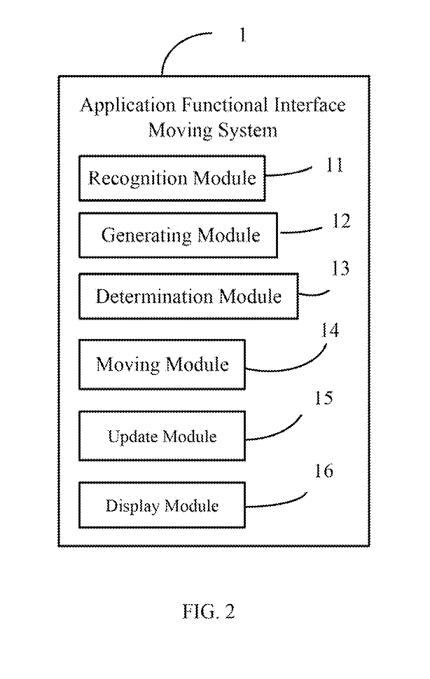

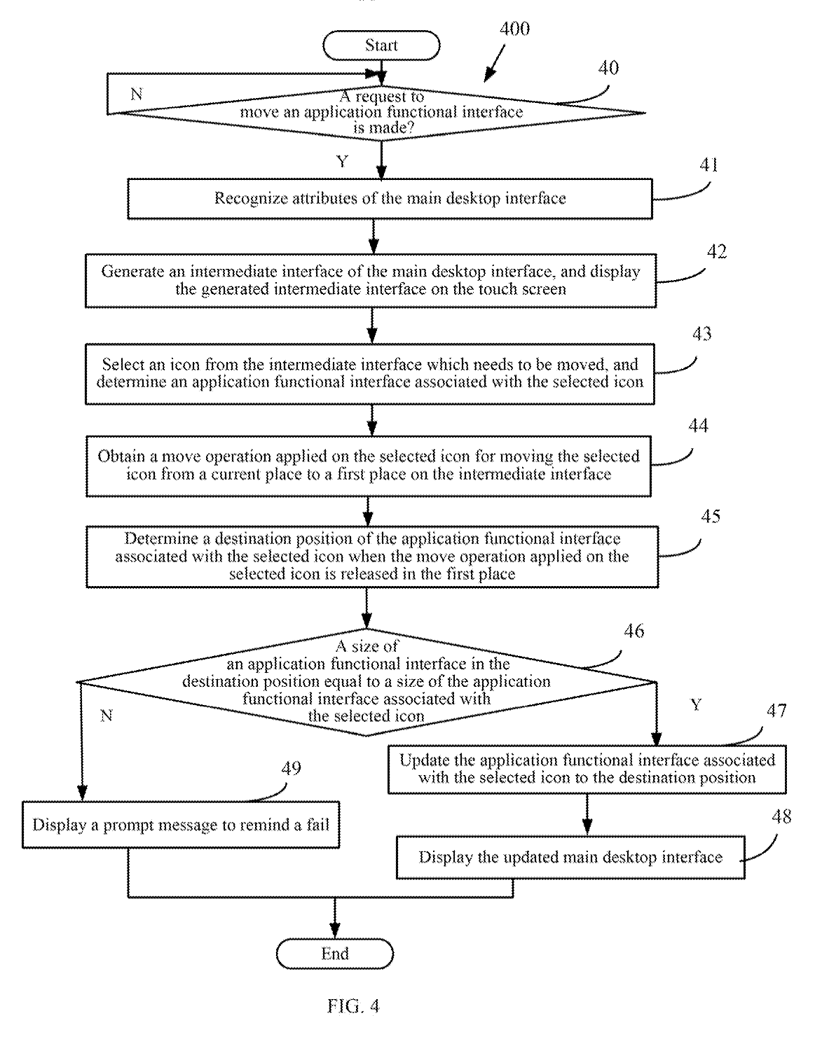

FIG. 2 is a block diagram of one embodiment of the function modules of the application functional interface moving system 1. In at least one embodiment, the application functional interface moving system 1 can include a recognition module 11, a generating module 12, a determination module 13, a moving module 14, an update module 15, and a display module 16. The function modules 11-16 can include computerized codes in the form of one or more programs, which are stored in the storage device 22. The at least one processor 23 executes the computerized codes to provide functions of the function modules 11-16. A detailed description of the functions of the modules 11-16 is given below in reference to FIG. 4.

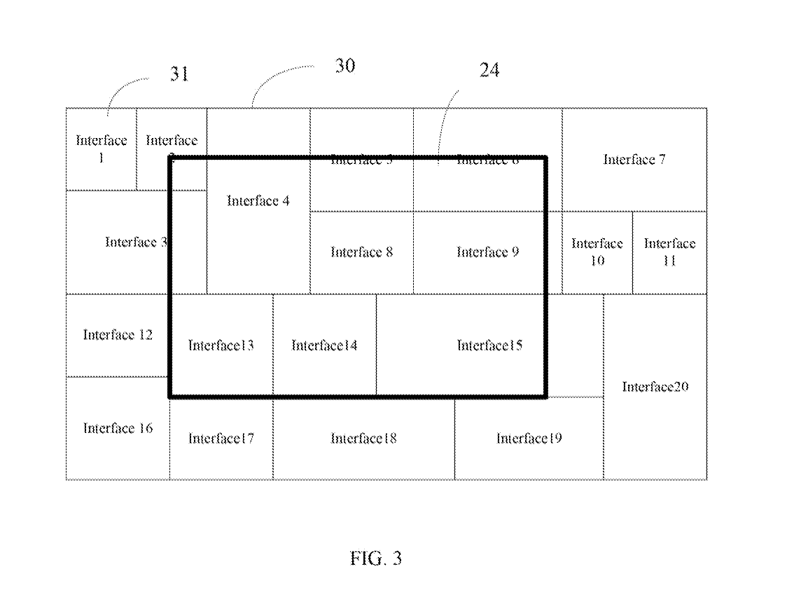

FIG. 3 illustrates a main desktop interface 30 of the electronic device 2. A part of the main desktop interface 30 is displayed on the touch screen 21. The displayed part of the main desktop interface 30 equal to a display area 24 of the touch screen 21. The main desktop interface 30 includes a plurality of application functional interfaces 31. A size, and a position occupied by each of the application functional interfaces 31 on the main desktop interface 30 is predefined. A function represented by each of the application functional interfaces is also predefined. Content displayed on each of the functional interfaces is associated with an information source of the electronic device. The information source includes, but not limited to, a picture, a video file, an audio file, a music file, or a game. When the application functional interface 31 is clicked or touched, an application associated with the application functional interface 31 is executed, or a file, a song, a picture associated with the application functional interface 31 is activated. The storage device 22 stores a relationship. The relationship defines relationships between each of the application functional interfaces, a position of the application functional interface arranged on the main desktop interface 30, a size of the application functional interface occupied on the main desktop interface 30, and an information source of the electronic device 2 associated with the application functional interface. In at least one embodiment, the picture displayed in the application functional interface is real time captured from the information source associated with the application functional interface. That is, a same application functional interface can display different pictures at different moments. The size of displayed pictures is same as the size of the application functional interface. In the illustrated embodiment, the application functional interfaces are arranged on the main desktop interface 30 one by one, and the main desktop interface 30 is similar to a map.

In at least one embodiment, an application functional interface 31 can be added on or deleted from the main desktop interface 30 in response to an operation. If an application functional interface 31 is added on the main desktop interface 30, an association relationship between the application functional interface 31 and an information source of the electronic device 2 is established. If an application functional interface 31 is deleted from the main desktop interface 30, an association relationship between the application functional interface 31 and the information source of the electronic device 2 is released, the association relationship is further deleted from the relationship stored in the storage device 22.

It is be to understand, in at least one embodiment, the display area of the touch screen 21 is limited, and the entire of the main desktop interface 30 needs a number of touch screens 21, such as N, cooperating with each other to be wholly displayed. Hereinafter, it is referred as the main desktop interface 30 contains N screens.

FIG. 4 illustrates a method for moving application functional interface. The example method 400 is provided by way of example, as there are a variety of ways to carry out the method. The method 400 described below can be carried out using the configurations illustrated in 1. 1-2, for example, and various elements of these figures are referenced in explaining example method 400. Each block shown in FIG. 4 represents one or more processes, methods or subroutines, carried out in the exemplary method 400. Furthermore, the illustrated order of blocks is by example only and the order of the blocks can change according to the present disclosure. The exemplary method 400 can begin at block 41. Depending on the embodiment, additional steps can be added, others removed, and the ordering of the steps can be changed.

At block 40, the recognition module recognizes whether a request to move an application functional interface is made. If yes, the process goes to block 41; if no, the process goes back to block 40.

At block 41, the recognition module recognizes attributes of the main desktop interface.

In the illustrated embodiment, the attributes of the main desktop interface 30 includes, but is not limited to, screens of the main desktop interface, quantities of the application functional interfaces contained by the main desktop interface 30, a size of each of the application functional interfaces occupied on the main desktop interface, and a position of each of the application functional interfaces located on the main desktop interface.

At block 42, the generating module generates an intermediate interface of the main desktop interface, and displays the generated intermediate interface on the touch screen.

In the illustrated embodiment, the area of the intermediate interface equal to the area of the display area of the touch screen 21. The generating module 12 generates the intermediate interface by minifying the main desktop interface 30 according to the attributions of the main desktop interface 30 recognized by the recognition module 11.

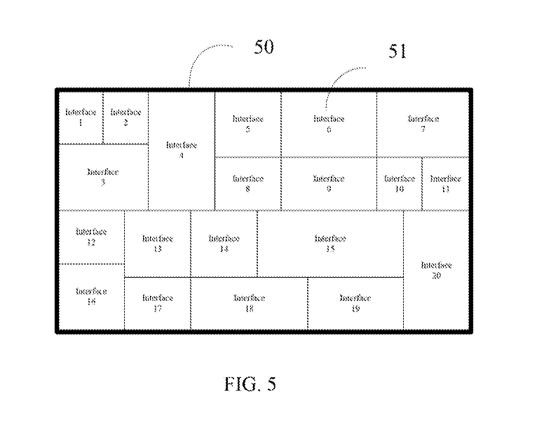

FIG. 5 illustrates a diagrammatic view of one embodiment of the intermediate interface 50. In the illustrated embodiment, the intermediate interface 50 is a thumbnail interface of the main desktop interface 30. The intermediate interface 50 includes a plurality of icons 51. Each icon 51 associates with an application functional interface 31. In particular, if an application functional interface 31 is displayed in a position of the main desktop interface 3, then an icon associated with the application functional interface 31 is displayed in a place of the intermediate interface 50, which is corresponding to the position of the main desktop interface 30. If no application functional interface 31 is displayed in a position of the main desktop interface 30, then a blank space is displayed in a pace of the intermediate interface 50, which is corresponding to the position of the main desktop interface 30. The intermediate interface 50 can receive operations and perform functions associated with the received operations. For example, the intermediate interface 50 zooms out to a predefined size when receiving a zooming-out operation.

At block 43, the determination module selects an icon from the intermediate interface which needs to be moved, and determines an application functional interface associated with the selected icon. The determined application functional interface also needs to be moved.

In other embodiments, after the application functional interface which needs to be moved is determined, the determination module 13 determines other application functional interfaces on the main desktop interface 30, which have same size as the application functional interface associated with the selected icon. The determination module 13 further marks icons associated with the determined other application functional interfaces on the intermediate interface 50. For example, the determination module 13 highlights the icons associated with the determined other application functional interfaces.

At block 44, the selection module obtains a move operation applied on the selected icon for moving the selected icon from a current place to a first place on the intermediate interface.

At block 45, the determination module determines a destination position of the application functional interface associated with the selected icon when the move operation applied on the selected icon is released in the first place.

In at least one embodiment, the determination module 13 determines a position on the main desktop interface 30 corresponding to the first place is the destination position of the application functional interface which needs to be moved. In other embodiments, the determination module 13 determines the destination position of the application functional interface which needs to be moved based on a sliding distance. In particular, the determination module 13 calculates a distance from an initial position of the application functional interface, which needs to be moved, to the destination position according to a formula D=L×(N+1), the element N denotes screens of the main desktop interface, the element L denotes a distance from the initial position of the main desktop interface corresponding to the current place of the intermediate interface to a position of the main desktop interface corresponding to the first place of the intermediate interface.

At block 46, the determination module determines whether a size of an application functional interface located in the destination position equal to a size of the application functional interface associated with the selected icon. If yes, the process goes to block 47; if no, the process goes to block 49.

In other embodiments, the block 46 can be removed.

At block 47, the update module updates the application functional interface associated with the selected icon to the destination position.

In the illustrated embodiment, when an application functional interface is displayed in the destination position, the update module 15 exchanges the application functional interface in the destination position with the application functional interface associated with the selected icon. When a blank is displayed in the destination position, the update module 15 replaces the blank of the main desktop interface with the application functional interface associated with the selected icon.

At block 48, the display module displays the updated main desktop interface.

In other embedment, the display module 16 synchronously closes or hides the intermediate interface while displays the updated main desktop interface. In an alternative embodiment, the display module 16 only displays a screen of the updated main desktop interface.

At block 49, the display module displays a prompt message to remind a fail.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for moving an application functional interface being executed by at least one processor of a computing device, the computing device comprising a main desktop interface, the main desktop interface having a plurality of application functional interfaces; the method comprising:
generating an intermediate interface of the main desktop interface, the intermediate interface being a thumbnail interface of the main desktop interface and comprising a plurality of icons, each of the icons associates with an application functional interface;
displaying the intermediate interface;
selecting one of the icons from the intermediate interface;
determining an application functional interface, which needs to be moved, associated with the selected icon;
obtaining a move operation applied on the selected icon for moving the selected icon from a current place to a first place on the intermediate interface;
determining a destination position of the application functional interface associated with the selected icon when the move operation applied on the selected icon is released in the first place;
updating the application functional interface associated with the selected icon to the destination position; and
displaying the updated main desktop interface.

2. The method according to claim 1, further comprising:
determining whether a size of an application functional interface located in the destination position equal to a size of the application functional interface associated with the selected icon; and
updating the application functional interface associated with the selected icon to the destination position when the size of the application functional interface located in the destination position equal to the size of the application functional interface associated with the selected icon.

3. The method according to claim 2, further comprising:
determining other application functional interfaces on the main desktop interface, which have same size as the application functional interface associated with the selected icon; and
marking icons associated with the determined other application functional interfaces on the intermediate interface.

4. The method according to claim 2, further comprising:
calculating a distance from an initial position of the application functional interface associated with the selected icon to the destination position according to a formula D=L×(N+1), wherein, N denotes screens of the main desktop interface, L denotes a distance from the initial position of the main desktop interface corresponding to the current place of the intermediate interface to a position of the main desktop interface corresponding to the first place of the intermediate interface.

5. The method according to claim 4, further comprising:
predefining a size, and a position occupied by each of the application functional interfaces on the main desktop interface, and function of each of the application functional interfaces; and
establishing an association relationship between content displayed on each of the functional interfaces and an information source of the computing device.

6. The method according to claim 5, further comprising:
exchanging an information source associated with the application functional interface, which is need to be positioned in the destination position, with an information source associated with the application functional interface positioned in the destination position.

7. The method according to claim 5, further comprising:
establishing an association relationship between the application functional interface and the information source of the computing device when the functional interface is added on the main desktop interface; and
releasing the association relationship between the application functional interface and the information source of the computing device when the application functional interface is deleted from the main desktop interface.

8. The method according to claim 5, further comprising:
recognizing attributions of the main desktop interface, wherein the attributions of the main desktop interface comprise screens of the main desktop interface, quantities of the application functional interfaces contained by the main desktop interface, a size of each of the application functional interfaces occupied on the main desktop interface, and a position of the application functional interface located on the main desktop interface.

9. The method according to claim 8, wherein the intermediate interface is generated by minifying the main desktop interface according to the recognized attributions of the main desktop interface.

10. The method according to claim 1, further comprising:
synchronously closing the intermediate interface while displaying the updated main desktop interface.

11. An electronic device, comprising:
a touch screen for displaying a main desktop interface having a multiple of application functional interfaces;
a processor; and
a storage device that stores one or more programs which, when executed by the at least one processor, cause the at least one processor to:
generating an intermediate interface of the main desktop interface, the intermediate interface being a thumbnail interface of the main desktop interface and comprising a plurality of icons, each icon associates with an application functional interface;
displaying the intermediate interface;
selecting an icon from the intermediate interface which needs to be moved;
determining an application functional interface, which need to be moved, associated with the selected icon ;
obtaining an operation applied on the selected icon for moving the selected icon from a current place to a first place on the intermediate interface;
determining a destination position of the application functional interface associated with the selected icon when the operation applied on the selected icon is released in the first place;
updating the application functional interface associated with the selected icon to the destination position; and
displaying the updated main desktop interface.

12. The electronic device according to claim 11, further comprising:
determining whether a size of an application functional interface located in the destination position equal to a size of the application functional interface associated with the selected icon; and
updating the application functional interface associated with the selected icon to the destination position when the size of the application functional interface located in the destination position equal to the size of the application functional interface associated with the selected icon.

13. The electronic device according to claim 12, further comprising:
predefining a size, and a position occupied by each of the application functional interfaces on the main desktop interface, and function of each of the application functional interfaces; and
establishing an association relationship between content displayed on each of the functional interfaces and an information source of the computing device.

14. The electronic device according to claim 13, further comprising:
exchanging an information source associated with the application functional interface, which is need to be positioned in the destination position, with an information source associated with the application functional interface positioned in the destination position.

15. The electronic device according to claim 14, further comprising:
establishing an association relationship between the functional interface and the information source of the computing device when the functional interface is added on the main desktop interface; and
releasing the association relationship between the functional interface and the information source of the computing device when the functional interface is deleted from the main desktop interface.

16. The electronic device according to claim 15, further comprising:
recognizing attributions of the main desktop interface, wherein the attributions of the main desktop interface comprise screens of the main desktop interface, quantities of the application functional interfaces contained by the main desktop interface, a size of each of the application functional interfaces occupied on the main desktop interface, and a position of the application functional interface located on the main desktop interface.

17. The electronic device according to claim 16, wherein the intermediate interface is generated by minifying the main desktop interface according to the recognized attributions of the main desktop interface.

18. A non-transitory storage medium having stored thereon instructions that, when executed by a processor of an electronic device, causes the processor to perform a method for moving application functional interface, the electronic device comprising a main desktop interface, the main desktop interface having a plurality of application functional interfaces; wherein the method comprises:
generating an intermediate interface of the main desktop interface, the intermediate interface being a thumbnail interface of the main desktop interface and comprising a plurality of icons, each icon associates with an application functional interface;
displaying the intermediate interface;
selecting an icon from the intermediate interface which needs to be moved;
determining an application functional interface, which need to be moved, associated with the selected icon;
obtaining an operation applied on the selected icon for moving the selected icon from a current place to a first place on the intermediate interface;
determining a destination position of the application functional interface associated with the selected icon when the operation applied on the selected icon is released in the first place;
updating the application functional interface associated with the selected icon to the destination position; and
displaying the updated main desktop interface.

19. The non-transitory storage medium according to claim 18, further comprising:
determining whether a size of an application functional interface located in the destination position equal to a size of the application functional interface associated with the selected icon; and
updating the application functional interface associated with the selected icon to the destination position when the size of the application functional interface located in the destination position equal to the size of the application functional interface associated with the selected icon.

20. The non-transitory storage medium according to claim 19, further comprising:
synchronously closing the intermediate interface while displaying the updated main desktop interface.
